(19) United States
(12) Patent Application Publication
(10) Pub. No.: US 2022/0284369 A1
(43) Pub. Date: Sep. 8, 2022

(54) EVALUATION SYSTEM FOR USERS IN A WORKSITE

(71) Applicant: MAFIC LIMITED, Essex (GB)

(72) Inventors: William Jeffrey Simon WOODHEAD, Surrey (GB); Adrian Roy CUNLIFFE, Ealing (GB)

(21) Appl. No.: 17/608,879

(22) PCT Filed: May 6, 2020
(86) PCT No.: PCT/GB2020/051107

§ 371 Date: Nov. 4, 2021

(30) Foreign Application Priority Data
May 7, 2019 (GB) 1906394.0

(51) Int. Cl. G06Q 10/06

(52) U.S. Cl. CPC G06Q 10/06316; G06Q 10/063114; G06Q 10/06395

(57) ABSTRACT

Disclosed herein is a worksite evaluation system for evaluating a plurality of users in a worksite comprising a plurality of data capture devices and an activity determination system configured to determine activity data of a user in dependence on the user's user data, wherein the activity determination system determines the activity data by using an activity classification algorithm, wherein the activity classification algorithm is trained to recognise a plurality of specific movement signatures of a user's head, with each specific movement signature corresponding to a different activity being performed. Each data capture device is disposed within a respective helmet for wearing by a respective user, wherein each data capture device is configured to obtain user data. Each data capture device comprises an inertial measurement unit configured to obtain motion data of a respective user's head as part of the user data; and a communication unit configured to transmit data dependent on the user data from the data capture device to a remote processing system.

The field of the present invention is a system for evaluating a worksite, in particular by evaluating the activities of workers in an industrial workplace.

Known methods of understanding production line mechanics have involved shadowing workers and manually collecting data relating to the activities of a small sample of workers at predetermined time intervals and keeping record logs. Other methods have involved requiring workers to report their activities and whereabouts themselves. Known methods are inefficient for tracking the activity of workers accurately and inferring detailed information regarding the operational performance of an industrial plant as a whole.

The present invention provides an improved system for determining the activities of workers, i.e. users of the system.

According to an aspect of the invention, a worksite evaluation system for evaluating a plurality of users in a worksite comprises a plurality of data capture devices, each data capture device being disposed within a respective helmet for wearing by a respective user, wherein each data capture device is configured to obtain user data. Each data capture device comprises an inertial measurement unit configured to obtain motion data of a respective user's head as part of the user data, and a communication unit configured to transmit data dependent on the user data from the data capture device to a remote processing system. The worksite evaluation system further comprises an activity determination system configured to determine activity data of a user in dependence on the user's user data, wherein the activity determination system determines the activity data by using an activity classification algorithm, wherein the activity classification algorithm is trained to recognise a plurality of specific movement signatures of a user's head, with each specific movement signature corresponding to a different activity being performed.

According to another aspect of the invention, a worksite evaluation method for evaluating a plurality of users in a worksite comprises obtaining user data from each of a plurality of data capture devices, each data capture device being disposed within a respective helmet for wearing by a respective user, wherein obtaining the user data comprises obtaining motion data of the respective user's head; and determining activity data of each user in dependence on the user data, wherein determining activity data comprises using an activity classification algorithm trained to recognise a plurality of specific movement signatures of a user's head, with each specific movement signature corresponding to a different activity being performed.

The present invention will now be identified by way of non-limiting examples with reference to the drawings, in which:

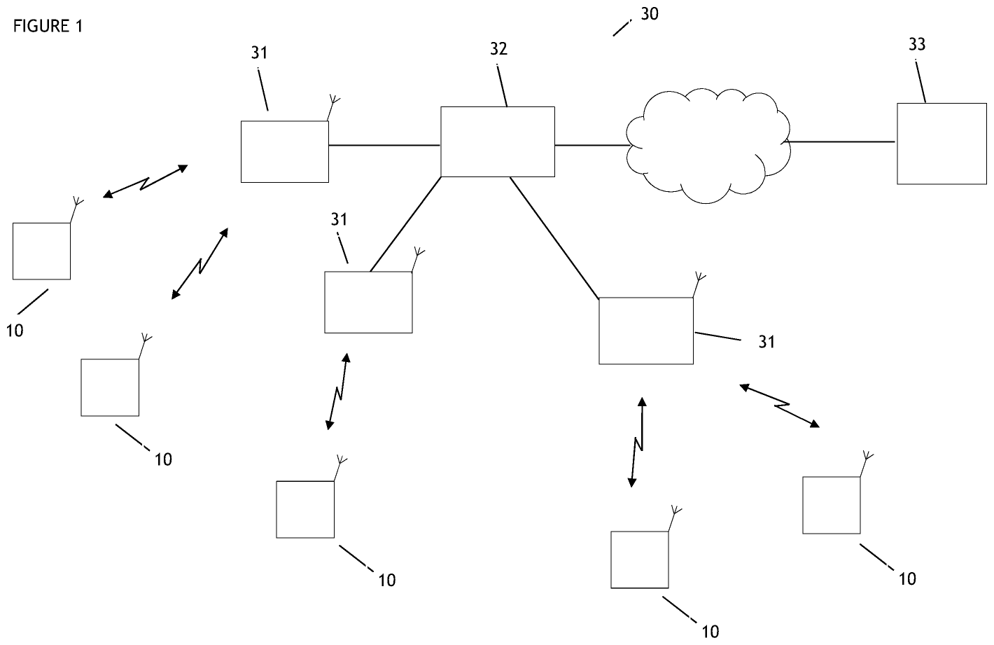

FIG. 1 shows an arrangement of a user activity determining system according to an embodiment;

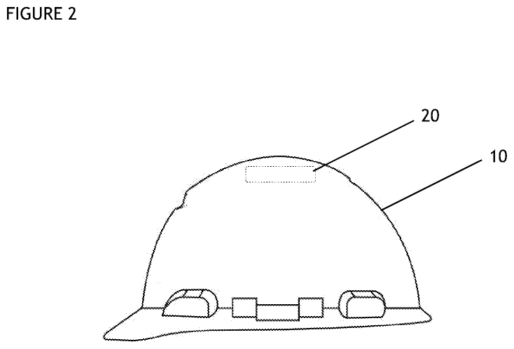

FIG. 2 shows an arrangement of a helmet according to an embodiment;

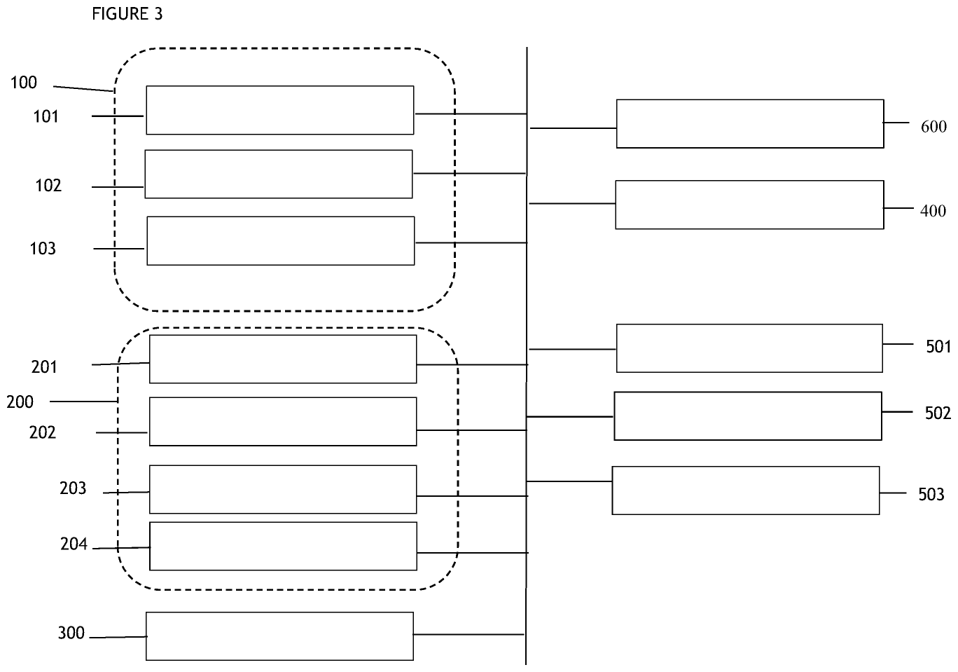

FIG. 3 shows an arrangement of a data capture device according to an embodiment;

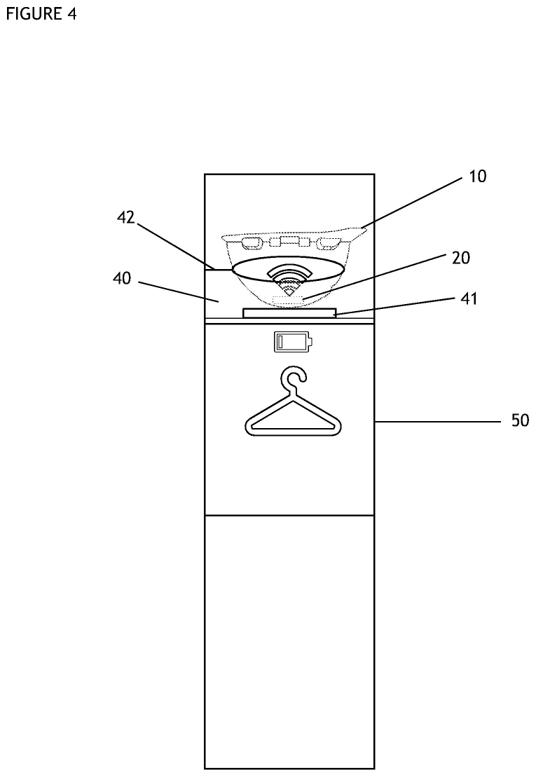

FIG. 4 shows an arrangement of a docking station according to an embodiment; and

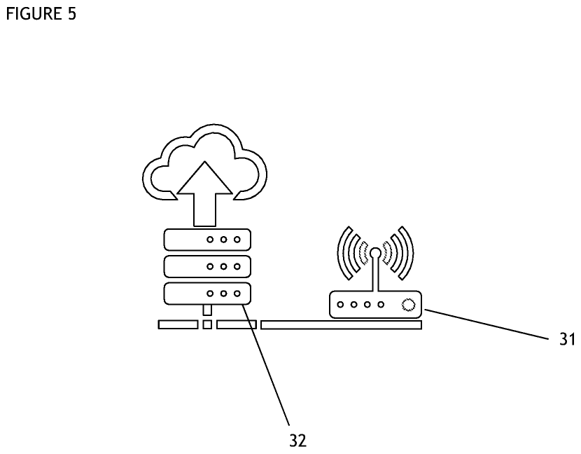

FIG. 5 shows an arrangement of a processing system according to an embodiment.

Embodiments provide a system evaluating a plurality of users in a worksite. The users may be people in any environment but are preferably workers in an industrial workplace.

As shown in FIG. 1, an arrangement of a worksite evaluation system according to embodiments includes a plurality of helmets 10, which are able to communicate with a remote processing system 30. In some arrangements, the remote processing system comprises a wireless gateway 31, a local server 32 and a processing server 33. Optionally, the helmets 10 are additionally able to communicate directly with one another without communicating via the processing system 30.

As shown in FIG. 2, each helmet 10 includes a data capture device 20. The helmet 10 may be any form of headwear suitable for wearing by an individual. In one arrangement, the helmet is a hard hat worn by a worker in a construction site. In other arrangements, the helmet may be a sports helmet, a hat, a military helmet, a transportation helmet or any other form of headwear to which the data capture device 20 may be suitably mounted.

In an arrangement as shown in FIG. 2, the data capture device 20 is located at a top portion of the helmet when worn by a user. In such an arrangement, the position of the data capture devices is furthest away from the centre of rotation of the user's head in the helmet. In another arrangement, the data capture device 20 is located at a rear portion of the helmet. In such an arrangement, the data capture device 20 is located away from the line of impact when the helmet receives an impact from above. In other arrangements, the data capture device may be located at other positions in the helmet, for example, at a side portion of the helmet, or at the front or back of the helmet.

In an arrangement, the helmet 10 may be a helmet to which a data capture device 20 has been retrofitted. In such an arrangement, the data capture device may be attached to an external or internal portion of the helmet 10. Alternatively, in an arrangement the helmet 10 may include a compartment inside the helmet to house the data capture device 20. In such an arrangement, the data capture device 20 may be sealed within the compartment. This may prevent tampering with the data capture device as well as prevent damage, such as liquid damage, to the data capture device 20. In another arrangement, the data capture device may be housed inside a compartment of the helmet 10, but may be accessible for connecting a wired connector to the data capture device 20.

FIG. 3 shows an arrangement of components in a data capture device 20. The data capture device 20 collects user data of a user of the helmet. The user data includes data from one or more sensors provided within the data capture device 20. The data capture device includes an inertial measurement unit (IMU) 100. Preferably, the data capture device 20 also comprises a communication unit 200.

The inertial measurement unit (IMU) 100 is an electronic device that obtains motion data relating to one or more of the specific force, angular rate, and the magnetic field surrounding the data capture device. The motion data forms part of the user data obtained by the data capture device 20. The IMU 100 may track the position and orientation in space of the data capture device 20 disposed within the helmet 10 as it is moved due to the user's activities. For example, when a user bends over, the IMU 100 measures the resulting movement of the data capture device 20. In arrangements where the data capture device is provided within a helmet 10, the motion data corresponds to the movement of the head of a user while performing various activities. Movement of a user's head is influenced by both the movement of the user's body and the specific movements of the head relative to the body. The head is a heavy part of the human body and acts as a counter-balance when performing activities, and thus serves as a good indicator of the activity being performed. This is because in general, it is difficult for the head to perform one activity while the body performs another. This contrasts with motion capture devices located on other parts of the human body like a wrist band or an arm band, which serve as a less good indicator of the activity being performed, because it is still possible to perform an activity such as walking or running, whilst doing various other motions with your hands/arms. In an arrangement, the data capture device 20 including the IMU is only located in the helmet, and is not located at another location on the body.

The IMU 100 may comprise an accelerometer 101, and a gyroscope 102. Optionally, the inertial measurement unit 100 additionally comprises a magnetometer 103. The IMU 100 may be a nine axis inertial motion sensor, including a three-axis gyroscope, a three-axis accelerometer, and a three-axis magnetometer. A nine-axis inertial motion sensor may provide detailed information for identification of activities and absolute orientation and heading of the user. The obtained motion data of the user may be referred to as the raw data obtained by the IMU. The motion data may be used for activity classification of the user which will be described in more detail later.

The communication unit 200 transmits data obtained by the data capture device 20. In an arrangement, the data transmitted by the data capture device is data dependent on the user data. Data dependent on the user data may include all of the user data obtained by the communication unit, or may only include a part of the user data obtained by the communication unit. In some arrangements, the data dependent on the user data transmitted may not include some parts of the user data, but instead may include additional data derived from the user data. For example, in some arrangements, the communication unit may not transmit the motion data obtained by the IMU, but instead may transmit activity data which is determined in dependence on the motion data. In these arrangements, the communication unit may still transmit other user data obtained by the data capture device, in addition to the activity data, which is included within the meaning of data dependent on the user data. In an arrangement, the communication unit 200 transmits the data obtained by any other sensor provided as part of the data capture device 20. The communication unit 200 may have any suitable means for wirelessly transmitting data. The communication unit 200 may also be able to receive data.

As shown in FIG. 3, the communication unit 200 may include one or more of a WiFi module 201, a Bluetooth module 202, and/or a cellular data module 203. The Bluetooth module 202 may be a Bluetooth Low Energy module, which has a low power consumption and cost. The cellular data module may be a mobile cellular network module using 3G, 4G, LTE, 5G, or GSM, for example. The communication module 200 may further include an NFC module for short range transmission, which may improve the security of the transmitted data, and may also be capable of determining if other helmets including a data capture device are in close proximity.

The communication unit 200 may alternatively or additionally include a mesh networking module 204 for allowing wireless data connections to be formed between data capture devices 20. The mesh networking module 204 may allow a data capture device 20 of one helmet to communicate directly with the data capture device 20 of another helmet. The mesh networking module 204 may use any appropriate protocol, such as the Thread network protocol using IPv6 over Low-Power Wireless Personal Area Networks (6LoWPAN), or Bluetooth mesh networking based on Bluetooth Low Energy. In one arrangement, the mesh networking module 204 may allow user data to be transmitted between data capture devices. For example, this may allow a data capture device 20 of a helmet which is not in range of a wireless gateway 31 of the processing system 30 to be nonetheless transmitted to the remote processing system by first transmitting the user data to a data capture device of a helmet 10 which is in range of a wireless gateway 31 of the processing system 30, which will in turn transmit the user data to the processing system. In another arrangement, the mesh networking module 204 may alternatively or additionally allow for a data capture device 20 associated with a helmet 10 to determine if another data capture device 20 associated with another helmet is nearby, and share notifications or warnings about hazards with one another without needing to communicate via the remote processing system.

As shown in FIG. 1, the remote processing system 30 may communicate with the data capture devices 20 of each of the respective helmets 10. The remote processing system 30 receives the user data transmitted from each of the data capture devices 20. In an arrangement, the processing system 30 includes one or more wireless gateways 31, a local server 32 and a processing server 33. The wireless gateways 31 receive and transmit data from and to each of the data capture devices 20. The wireless gateways 31 may include a WiFi and/or a Bluetooth module to communicate with the data capture devices 20, and optionally may also include a mesh networking module. The wireless gateways 31 may be connected to a local server 32. The local server 32 receives data obtained from all the wireless gateways 31. The local server 32 may include a local data storage unit to store the received data. The local server 32 uploads the data to a processing server 33. The processing server 33 may be remote from the local server 32 and communication between the processing server and the local server may be over the Internet.

The data capture device 20 may include a location unit 300. The location unit 300 is able to obtain location data of the data capture device 20, and may form part of the user data which is transmitted to the remote processing system 30. The location unit 300 may be a GNSS (Global Navigation Satellite System) receiver. A GNSS receiver may use one or more of GPS, GLONASS, and/or any other suitable satellite navigation system. In other arrangements, the data capture device 20 may not include a dedicated location unit, but location data may be obtained from the communication unit, for example using the WiFi module 201, the cellular data module 203, or the Bluetooth module. In an arrangement, the location data may be obtained from the Bluetooth module of the data capture device in combination with pre-installed Bluetooth transmitters installed throughout the target facility in which the helmets are to be used. In an alternative arrangement, a dedicated location unit 300 is not provided in the data capture device 20, but instead a user may be able to use a smartphone or other device fitted with a GNSS receiver in order to be able to obtain location data of the user. This location data may be communicated independently to the processing system 30 by means of software on the smartphone or other device.

The data capture device 20 may additionally include an ultra-wideband (UWB) unit. The UWB unit may be used for obtaining location data, but may additionally also be used for communication purposes. The UWB unit uses short-range radio technology, and allows for accurate localisation of a UWB unit present in a data capture device 20 using the transit time (time of flight) between the UWB unit in the data capture device 20 and a plurality of UWB nodes located in the local environment of the user, for example an industrial worksite. A UWB unit may provide accurate position information of a user wearing a data capture device equipped helmet indoors. For example, a UWB unit may allow location data precise enough to determine whether or not a user is sitting down or standing, and may allow for the orientation of a user to be determined. In one arrangement, the location unit 300 includes both a GNSS unit for outdoor location tracking of a user, and a UWB unit for indoor tracking of a user. The UWB nodes and UWB units may be used in indoor and/or outdoor environments.

In an arrangement, a plurality of UWB nodes are located at various positions around an industrial site. Optionally, the UWB nodes may be included as part of the wireless gateways 31. The plurality of UWB nodes allow each helmet equipped with a data capture device 20 with a UWB unit to be accurately located. If the UWB nodes are not integrated into the wireless gateways 31, then the UWB nodes may transmit the location data, and/or any other data to the processing system 30. If the UWB nodes are integrated into the wireless gateways 31, then the wireless gateways will transmit the location data as described above.

In an arrangement, the data capture device 20 further comprises a data storage unit 400. The data storage unit 400 may store the user data obtained by the data capture device 20 during use. The data storage unit 400 may be a flash drive or a drive with removable storage.

The data capture device 20 includes a battery 600. The battery may be a rechargeable battery to power the data capture device 20. The battery may be any suitable type of battery, such as a lithium-ion, or a lithium-ion polymer battery. In one arrangement, the capacity of the battery may be sufficient to continuously power the data capture device for three days or more. The battery may be connected to and charged with a wireless charging induction coil in the data capture device 20. Alternatively, or additionally, the battery may be charged by means of a wired charging port provided on the data capture device. In such an arrangement, it may be possible to remove the data capture device 20 from the helmet 10 to be charged. Alternatively, it may be possible to access the charging port when the data capture device is fitted in the helmet to charge the data capture device without need for removing the data capture device from the helmet. This may be achieved by providing the charging port in a location accessible from the inside of the helmet, or providing a port on the outside of the helmet for accessing the charging port of the data capture device 20. Alternatively or additionally, the helmet may be provided with an energy harvesting device to recharge the battery. The energy harvesting device may supplement or replace the induction charging coil described above. The energy harvesting device may harvest energy in any suitable manner, including thermal energy, solar energy, vibration energy, and/or radio frequency energy. The energy harvesting device may include a photovoltaic energy generator, a thermoelectric energy generator, a kinetic energy generator and/or a radio frequency energy generator to harvest the above-mentioned forms of energy. For example, the helmet 10 may be provided with a solar cell connected with the data capture device 20 in order to power and charge the data capture device.

The data capture device may include one or more of a thermometer 501, a barometer 502, and a hygrometer 503. These may allow for the environmental conditions surrounding a user wearing a helmet 10 to be detected. The data from the thermometer, barometer, and/or hygrometer may also be transmitted to the processing system 30 as part of the user data. Based on the temperature data, the pressure data and the humidity data, the processing system may be able to make determinations such as, the environment surrounding a given user is too hot, or too humid, for example. This may allow for monitoring of the environmental conditions within a workplace.

In an arrangement, the data capture device may include an altimeter. An altimeter may track changes in a user's elevation around a worksite. The data capture device may further include other units able to determine other environmental conditions. For example, if the workplace of the users is an environment containing radioactive materials, a Geiger counter may be provided. This contextual information can also be used to improve the activity classification of the users.

In an arrangement, there is provided an activity determination system for determining an activity that is performed by a user wearing the helmet 10. The activity determination system performs the activity determination in dependence on the user data which is generated by the one or more sensors provided as part of the data capture device 20. For example, the activity determination system may obtain the motion data from the IMU and use the motion data in order to determine an activity performed by the user. The activity determination system may additionally use other user data from any of the other sensors that may be present on the data capture device, for example the altimeter, the location unit, the communication unit, etc. in order to supplement the data from the IMU in determining the activity performed. As an example, data from both an altimeter and the IMU may be able to more accurately determine that a user is walking up a flight of stairs than if only the IMU were provided. As another example, data from both the IMU and the location unit may be able to more accurately determine how quickly a user is moving, such as walking or running, than if only the IMU were provided.

In an arrangement, the activity determination system performs human activity recognition (HAR) using an activity classification algorithm which has been trained using machine learning and/or AI techniques. The HAR is able to distinguish between different types of activities that may be performed by the users in the worksite. For example, the HAR may be able to identify common activities such as sitting down, walking, running, jumping, bending over, and lifting an object. However, the activity classification algorithm may be able to identify more complex activities, such as operating vehicles or operating machinery that may be present on the worksite, or performing specific construction activities such as using a power screw, drilling holes, using a nail gun, laying bricks, and/or welding materials together. In order to achieve this level of detail in identifying the activities performed, the activity classification algorithm can be trained using data from specific worksites, in order to be able to customise the HAR to the specific work environment that a user will be working in. The HAR works by training the activity classification algorithm to distinguish between the specific movement signatures of a user's head whilst performing different activities in a worksite. Each activity that is performed by a user may have a different specific movement signature of the user's head. This is because, as described above, the head serves as a counter-balance for a user's body and may provide a good indicator of what activity is being performed. In an arrangement, the trained activity classification algorithm is provided with the motion data from the data capture device as an input, and then compares the motion data to the specific movement signatures of the different activities that the activity classification algorithm has been trained to identify. The activity classification algorithm may then output an activity that the user is performing or has performed in dependence on such a comparison. The activity classification is output as activity data. Furthermore, as described above, the activity determination system may use the user data from the other sensors present on the data capture device to supplement the motion data in order to further assist in determining what activity is being performed, such as the location data. In further arrangements, the activity classification algorithm may combine data from multiple users who may be working together on a single task to determine the activity data of those users. For example, two users may be lifting a wheelbarrow into a container, or a user may be standing on a ladder whilst another user may be passing objects to the user on the ladder. Additionally, the activity classification algorithm may be trained to identify the user's posture, such as upright or slouched.

In an arrangement, each data capture device 20 includes a processor unit which is provided with an activity determination system as described above. Each data capture device may perform the HAR in order to determine an activity that is being performed by a user and outputs the result as activity data. The activity data is then transmitted by the communication unit to the remote processing system 30. In an arrangement, the processor unit of the data capture device 20 will determine the activity data based on the user data and then will transmit the activity data along with a date and time stamp corresponding to the time at which the activity was performed by the user to the remote processing system 30. In an arrangement, the raw data such as the motion data obtained by the IMU is not transferred to the processing system. This may reduce the total amount of data needed to be transmitted by the data capture device because the activity data is transmitted in place of the motion data. This may enable real-time output of the activities being performed by the user in a case where the motion data from the IMU is too large to transmit using a given communication method. This may also reduce the demand on the processing system because activity data is determined on each of the data capture devices of each user.

In an alternative arrangement, the data capture device does not perform the HAR itself, but instead the remote processing system, preferably the processing server is provided with the activity determination system. In such an arrangement, each data capture device 20 transmits all of the user data, including the motion data, to the processing system. In such an arrangement, the processing system performs the HAR and determines the activity data of each of the users using the activity classification algorithm as described above. Providing the activity determination system as part of the processing system instead of on a processor unit provided on the data capture device may enable more sophisticated activity classification algorithms to be used, owing to a potentially greater amount of computational power, however this increases the required data that must be transmitted between the data capture device 20 and the processing system. The data capture device 20 may be charged using a wireless charging induction coil. This may enable the data capture device to be charged without needing to obtain direct access to the data capture device, because the helmet may simply be placed adjacent to a corresponding wireless charging station. This may prevent damage to or tampering with the data capture device and may provide a helmet 10 which does not require any further interaction between the user and the helmet beyond the ordinary use of the helmet.

As shown in FIG. 4, a docking station 40 is provided to receive and to house a helmet 10 and respective data capture device 20. As shown in FIG. 4, a docking station 40 may be located within a locker 50 provided for use by a user. The docking station is provided to store the helmet when not worn by a user. The data capture device may include a wireless charging coil and the docking station 40 may include a wireless charging station 41 that wirelessly charges the data capture device when the helmet is placed on, or near, the wireless charging station. The docking station 40 may include a helmet locating ring 42, to securely hold the helmet in position and ensure that the data capture device is located in the correct position with respect to the wireless charging station 41. There may be a status light on the docking station to identify correct placement of the helmet. Each of a plurality of docking stations 40 may determine if a helmet has been correctly placed in the docking station, and initiate charging of the data capture device 20. A wireless gateway 31 may be placed in proximity to one or more docking stations.

The data capture device may also be able to download and update the data capture device firmware from the processing system 33 when placed in the docking station.

In an arrangement, the data capture device 20 of a helmet 10 may automatically begin collecting user data once it is determined that the helmet has been removed from the docking station. Alternatively, the data capture device may begin collecting user data once it is determined that a user has placed the helmet 10 on their head. If the data capture device determines that no activity is being performed by the user, or if the helmet has been put down for a prolonged period of time, then the data capture device may pause the collection of user data. This may prolong the battery life of the data capture device.

In an arrangement, the data capture device may transmit the user data in real-time to the processing system 33 using the communication unit 200 In such an arrangement, the user data is transmitted in real time and received by the processing system 30. This may allow the processing system to obtain the activity data and data dependent on the user data in real time. In arrangements where the data capture device additionally includes a location unit 300, it is possible to determine the activity and location of each of the users in real time.

The data capture device 20 may also include a haptic feedback unit. The haptic feedback unit may be vibrated to deliver a notification to a user, such as a warning to a user. In such an arrangement, the processing system 33 may monitor or determine the real time location of each of the users, and send a signal to a data capture device when a user is in close proximity to a hazard so as to cause the haptic feedback unit to vibrate to deliver a warning to the user. For example, if users are working a construction site, a user may be notified of moving vehicles in close proximity or lifted loads overhead. Providing vibration warnings to a user may help to ensure that the user is aware of the warning as opposed to providing only audible notifications which may be drowned out by ambient noise. In another arrangement, the data capture device of a first helmet may be able to communicate with the data capture device of one or more other helmets, using the mesh networking module or otherwise, and may send a signal to the data capture device of another helmet if the user of the first helmet is performing an activity which may pose a hazard to the user of the other helmet. In another arrangement, optionally or additionally, a Bluetooth Low Energy sensor may be able to detect signals from Bluetooth modules associated with vehicles or heavy equipment which may serve as a warning to the user wearing the helmet using the haptic feedback unit, or to the operator of the vehicle or heavy machinery.

In an arrangement, data sent to the processing system 30 from each data capture device 20 may be used to track the exposure of each user to injury when performing hazardous activities to ensure that a user's health and safety is not compromised. In an arrangement, the processing system 30 may monitor the exposure of a user to a hazardous activity by monitoring a number of predetermined metrics associated with those hazardous activities. A hazardous activity may be one that may pose a risk to the user if performed for an extended period of time. By monitoring associated metrics with those activities, the processing system may determine when a user is approaching a threshold exposure limit which may indicate that the user is at risk of injury from that activity. In response to the determination of an activity that may be hazardous, the processing system may measure the exposure of a user in dependence metrics such as the time during which the activity is performed, the intensity at which the activity is performed, and/or other environmental factors that may also manifest due to the activity, such as noise. By monitoring a user's exposure in terms of the activity data, it is not necessary to have a separate sensor for each individual hazard that may be encountered on a worksite and the hazards may instead by identified by the activities of users in the worksite and the locations at which the hazards and users are present. In an arrangement the processing system may monitor the hand and arm vibrations (HAV) of a user when operating vibrating machinery. Using the activity data it is possible to determine that a user is operating the vibrating machinery, and then in dependence on the data transmitted by the user's data capture device, optionally along with information from the machinery manufacturer, the processing system may then measure the exposure to HAV and compare this to safe limits. The processing system may deliver warnings to the user using any of the techniques described herein to alert the user that the safe limits are being approached or have been passed. In other arrangements, the processing system may monitor exposure to other hazards such as gases, noise, etc.

In an arrangement, the processing system may monitor slips and trips of users in a worksite. The slips and trips may include those that result in a fall of the user, and also those that do not result in a fall (micro-slips and micro-trips). The processing system may generate a profile of high risks and low risks in the worksite in dependence on the nature of the slips and trips, including the micro-slips and micro-trips. The profile of risks may include details such as the activity being performed, the location, the trade, and the experience and age of the user for each slip and trip, in order to provide a detailed understanding of the nature of the slips and trips. The processing system may then output the profile of risks so that the worksite may be better managed to reduce or eliminate the instances of slips and trips. In an arrangement, the processing system may update the allocation of users in the worksite in dependence on the profile of risks.

In an arrangement, the processing system may monitor the working times of the users on a worksite using the user data. In dependence on the working times of a user, it may be determined that a user has worked longer than the set working hours. In such an instance, a user is at risk of being fatigued, which may increase risk that a user will be involved in a dangerous incident. If such a determination is made, the processing system may deliver a warning to the user that they have exceeded the safe working hours limit. In another arrangement, additionally or alternatively, the working hours data may be used to monitor which activities are under-resourced. For example, if based on the activity data, the processing system determines that users are performing a specific activity longer than their set working hours, it may be determined that this activity is under resourced, and may allocate additional users to that activity.

The data capture device 20 may also include a microphone and a spectrum analyser. In an arrangement, the microphone and spectrum analyser may obtain sound data from the surroundings of the user in order to enable determinations to be made regarding activity occurring in proximity to a user. The sound data may be provided to the activity determination system in order to supplement the motion data and/or any another data in order to enable the activity determination system to determine the users' activities. In an arrangement, the spectrum analyser will determine the volume and frequency of a particular activity or type of machinery operated and output the corresponding sound data to the activity classification system. For example, if a user is using a jackhammer, the activity determination system may be able to combine the motion data and the sound data in order to accurately determine that a jackhammer is being operated. In another example, if a user is welding, then the characteristic sound profile of welding may be identified using the spectrum analyser and the sound data may be used by the activity determination system to identify that a user is welding.

In an arrangement, using a microphone and a spectrum analyser may detect hazards around the user. For example, the microphone may be able to detect approaching objects such as vehicles and to deliver a warning to the user using the haptic feedback unit as described above and/or with a loudspeaker. In another arrangement, a microphone and loudspeaker may allow for communication between a user wearing a helmet 10 and another user wearing a helmet 10. Alternatively, or additionally, a microphone and loudspeaker may allow for communication between a user wearing a helmet 10 and the processing system 30 and/or a remote user/manager.

In an arrangement, the data capture device may be paired with software provided on a smartphone which can control and assist the functionality of the data capture device 20. An arrangement has previously been discussed, in which a location unit 300 is not provided as part of the data capture device 20, and smartphone software is used to collect location data of the user. The smartphone software may act as a management interface for the data capture device. The application may be used to associate a user's pseudo identification with the data capture device in the helmet. Additionally, or alternatively, the smartphone software may enable messaging between a user and the processing system 30. For example, the processing system 30 may be able to deliver text based notifications to a user in order to provide instructions. In an arrangement, the software may also provide information relating to the activity that a user has performed as a historical log. The smartphone application may also include personal user metadata input, for example information relating to the height, weight, experience and role of the user.

In an arrangement, processing system may use the data obtained from each data capture device of one or more users in a worksite in order to make determinations about how the workforce is operating and the amount of progress that is being made on a given project.

In an arrangement, an amount of work completed may be measured based on a total number of activity events that have taken place. The amount of work completed is a measure of the activities performed in a worksite obtained based on the activity data of one or more of the users. In certain forms of construction work, involving high repetition, non-complex activities, the number of activity events that have taken place may give an indication of the amount of work complete. Comparing this number to the total number of activity events that are expected to take place may give an indication of the degree of project completion. The degree of project completion is a measure obtained based on the amount of work completed compared to an estimated overall volume of work, which may be determined in a number of ways. Comparing the number of activity events to other resources or metrics, such as time, number of user working, accidents, utilities consumed, and/or equipment breakdowns, a measure of the productivity may be obtained. An activity event may correspond to an instance of an activity being performed, as determined by the HAR techniques as described above. For example, if it is determined that the activity that a user is performing is installation of screws using a power screw, an activity event may be the installation of a single screw, and the number of screws installed may be determined by tracking the number of such activity events that take place. In a corresponding way, activity events may include number of nails installed using a nail gun, number of bricks laid, seconds or metres of weld laid down, or number of plasterboard panels carried and installed, etc. It will be appreciated that there may be many activities that may be performed on a worksite, and all of these are intended to be covered by the techniques described herein. Each activity that may be performed may have a corresponding activity event that can be measured and tracked in order to provide information regarding the amount of work completed, which may then be used to measure the progress of a project and the productivity of a user or the workforce. For example, in the building of a residential structure, the total number of bricks required to be laid down may be known in advance. Therefore, the amount of work completed and thus the degree of project completion may be estimated by the number of bricks laid down as determined by the activity data.

In an arrangement, the amount of work completed and the progress of a project may be alternatively or additionally measured by determining what activities are being performed at a given time. A project may be broken down into a series of stages, each of which has a set of associated activities. In general, a project will not advance from a first stage to a second stage until all of the activities required to be performed during the first stage have been completed. Furthermore, certain activities are only performed in certain stages, which can be used to determine what stage a project is at. The completion of a stage may correspond to a particular project milestone having been completed, corresponding to a particular amount of work completed. In an arrangement, the identification of a stage of a project may be determined using a stage determination algorithm which uses a machine learning/AI system which has been trained on historical data in order to determine what stage a project is at. The stage determination algorithm may use information such as the collective activities by a plurality of users in a worksite, the locations of the activities, and/or the timings at which the activities are performed in order to make the stage determinations. The stage determination algorithm may use the activity data of the users, or may use the raw data obtained by the data capture devices of each of the users directly without calculating the activity data first.

For example, in a case of construction of a residential building, a first stage may be characterised by activities such as use of backhoe diggers and/or pilling machines to set up the foundations of the building. A subsequent stage may be characterised by activities such as laying bricks or installing walls. A final stage may be characterised by activities such as painting walls. In this manner, by determining the activities performed by one or more users in a worksite, and associating the determined activities with activities corresponding to a certain stage of a project, it is possible to track the amount of work that has been completed, to track the progress made on a project.

In an arrangement, the degree of project completion may be calculated by determining the stages of the project which have been completed, and comparing this to the total number of stages that need to be completed. The level of project completion may also be calculated by associating particular stages with project milestones which correspond to the degree of completion. For example, in a case of constructing a residential building, a milestone of 50% project completion may be associated with having finished constructing the building structure such as the walls and the roof, which may correspond to the completion of a stage. Additionally or alternatively, the degree of project completion may be calculated by comparing the stages that have been completed to historical data from similar projects.

In another arrangement, the amount of work completed and the degree of project completion may be calculated using all of the above mentioned techniques together. The amount of work completed may be based on both the number of activity events that have taken place, together with the distribution and types of activities that are taking place. The degree of project completion may be determined using a machine learning/AI algorithm that has been trained on historical data and may include both the number of activity events that have taken place, together with the distribution and types of activities that are taking place, optionally along with data relating to the number of users working, meteorological data, and/or activities of specific key users.

In an arrangement, based on the amount of work completed and/or the degree of project completion, it is possible to make determinations of how to allocate users in a worksite and identify the number of users that are required.

In an arrangement, performance data may be obtained in dependence on the degree of project completion when compared against a suitable metric such as time, consumable, man-hours burnt, overheads, overtime, additional shifts, preparatory work, and/or non-productive time. The performance data may be used to evaluate the performance of various aspects of a project. For example, the performance data may be used to evaluate the introduction of a new tool, working practice PPE, working hours, location, working conditions, project execution strategy, build order, specific design.

Performance data may also be aggregated industry wide and then slice by the appropriate metric to gain an understanding of how the industry or specific parts of the industry is performing as a whole. This could be used by industry leaders or governments to understand where the biggest delays in construction occur, dispute resolution cases on contract completion. Information on productivity levels of a particular trade working in particular conditions can be understood and historical performance data may be kept as a record of activities that took place in situations where evidence of productivity is needed.

In an arrangement, upon activation of a fire alarm or a drill in a worksite, all users must muster at an appropriate point and a role call is taken. In such a situation, the processing system may automatically determine which users are present in the mustering and which users are not. This may remove the need to perform a manual role call which may lead to errors in identification of presence of personnel. Additionally, based on the user data of a user who is not determined to be at the mustering point, the processing system may determine the location and activity of the user who is absent. For example, in the case of a fire emergency, it may be identified if an absent user is incapacitated inside a building which is on fire, which may enable a rescue team to plan accordingly.

Embodiments include a number of modifications and variations to the above-described techniques.

In a variation of the above described user activity determining system, it will be appreciated that the user activity determining system may be implemented with only the data capture device 20 and the processing system, without the need for a helmet 10. The data capture device 20 may be a standalone device given to a user, or the data capture device 20 may be integrated into another apparatus which is carried by a user, e.g. a shoe or a belt. It will be readily understood that the presence or absence of a helmet 10 does not change the functionality of the user activity determining system as described above. For example, data capture devices 20 may be given to customers or visitors in a shopping centre, or other venue such as a stadium or concert hall, or festival. This may enable information to be obtained about the facility and how users interact with the facility.

Any, or all, of the operations described throughout the present document may be performed automatically by one or more computing devices and/or other devices.

The methods and description thereof herein should not be understood to prescribe a fixed order of performing the method steps described therein. Rather the method steps may be performed in any order practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A worksite evaluation system for evaluating a plurality of users in a worksite comprising:
a plurality of data capture devices, each data capture device being disposed within a respective helmet for wearing by a respective user, wherein each data capture device is configured to obtain user data, wherein each data capture device comprises:
an inertial measurement unit configured to obtain motion data of a respective user's head as part of the user data; and
a communication unit configured to transmit data dependent on the user data from the data capture device to a remote processing system; and
an activity determination system configured to determine activity data of a user in dependence on the user's user data, wherein the activity determination system determines the activity data by using an activity classification algorithm, wherein the activity classification algorithm is trained to recognise a plurality of specific movement signatures of a user's head, with each specific movement signature corresponding to a different activity being performed.

2. The worksite evaluation system of claim 1, wherein each data capture device comprises a respective processor unit, each processor unit comprising an activity determination system;
wherein the activity data generated by each activity determination system is transmitted to the remote processing system.

3. The worksite evaluation system of claim 1, wherein the remote processing system comprises the activity determination system;
wherein the remote processing system is configured to determine activity data of each of the plurality of users.

4. The worksite evaluation system of claim 1, wherein the processing system is configured to determine an amount of work completed in dependence on the activity data of each of the users.

5. The worksite evaluation system of claim 1, wherein the processing system is configured to determine an amount of work completed in dependence on the activity data of each of the users, and wherein the amount of work completed is determined in dependence on a number of activity events determined in dependence on the activity data, each activity event corresponding to an instance of an activity being performed.

6. The worksite evaluation system of claim 1, wherein the processing system is configured to determine an amount of work completed in dependence on the activity data of each of the users, and wherein the amount of work completed is determined in dependence on a stage of the project, wherein the stage of the project is determined in dependence on a stage determination algorithm trained to recognise the stage of a project in dependence on the activity data from a plurality of the users.

7. The worksite evaluation system of claim 1, wherein the processing system is configured to determine an amount of work completed in dependence on the activity data of each of the users, and wherein the processing system is further configured to determine a degree of project completion in dependence on the amount of work completed.

8. The worksite evaluation system of claim 1, wherein each data capture device comprises a location unit configured to obtain location data of the data capture device as part of the obtained user data.

9. The worksite evaluation system of claim 1, wherein each data capture device comprises a location unit configured to obtain location data of the data capture device as part of the obtained user data, and wherein the location unit includes an ultra-wideband unit configured to obtain location data based on signals from a plurality of ultra-wideband nodes.

10. The worksite evaluation system according to claim 1, wherein the remote processing system comprises:
one or more wireless gateways configured to communicate with a plurality of data capture devices and receive the data from each of the plurality of data capture devices,
a local server configured to receive the data from the one or more wireless gateways, and
a processing server configured to make determinations in dependence on the received data.

11. The worksite evaluation system according to claim 1, further comprising a plurality of docking stations for the plurality of helmets, each docking station being configured to receive a respective helmet.

12. The worksite evaluation system according to claim 1, further comprising a plurality of docking stations for the plurality of helmets, each docking station being configured to receive a respective helmet, and wherein each docking station comprises an induction coil for wirelessly charging the data capture device of a respective helmet when docked in the docking station.

13. The worksite evaluation system according to claim 1, wherein each helmet includes an energy harvesting device configured to harvest energy from at least one of: solar energy, thermal energy, kinetic energy and radio-frequency energy.

14. The worksite evaluation system according to claim 1, wherein the communication unit of each data capture device includes a mesh networking module to enable direct communication between a first helmet of the plurality of helmets and a second helmet of the plurality of helmets.

15. The worksite evaluation system according to claim 1, wherein the processing system is configured to monitor a user's exposure to a predetermined metric in dependence on the activity data, and to notify the user when a threshold metric exposure amount has been exceeded.

16. The worksite evaluation system according to claim 1, wherein the processing system is configured to monitor a user's exposure to a predetermined metric in dependence on the activity data, and to notify the user when a threshold metric exposure amount has been exceeded, and wherein the predetermined metric is hand and arm vibration.

17. The worksite evaluation system of claim 1, wherein the processing system is configured to identify users' slips and trips in dependence on the activity data, and generate a profile of risks in dependence the users' slips and trips.

18. A worksite evaluation method for evaluating a plurality of users in a worksite comprising:
obtaining user data from each of a plurality of data capture devices, each data capture device being disposed within a respective helmet for wearing by a respective user, wherein obtaining the user data comprises obtaining motion data of the respective user's head;
determining activity data of each user in dependence on the user data, wherein determining activity data comprises using an activity classification algorithm trained to recognise a plurality of specific movement signatures of a user's head, with each specific movement signature corresponding to a different activity being performed.

19. The worksite evaluation method of claim 18, further comprising transmitting data dependent on the user data from each of the plurality of data capture devices to a remote processing system,
wherein the step of determining activity data is performed by the remote processing system, wherein the remote processing system determines the activity data of each of the plurality of users.

20. The worksite evaluation method of claim 18, wherein the step of determining activity data is performed by each of the plurality of data capture devices, each data capture device determining the activity data of its respective user in dependence on the user data obtained by said data capture device, further comprising the step of transmitting data dependent on the user data, including the activity data, from each of the plurality of data capture devices to a remote processing system.

21. The worksite evaluation method of any claim 18, further comprising a step of determining an amount of work completed in dependence on the activity data of each of the users.

22. The worksite evaluation method of claim 18, further comprising a step of determining an amount of work completed in dependence on the activity data of each of the users, and wherein determining the amount of work completed is performed in dependence on a number of activity events determined in dependence on the activity data, each activity event corresponding to an instance of an activity being performed.

23. The worksite evaluation method of claim 18, further comprising a step of determining an amount of work completed in dependence on the activity data of each of the users, and wherein determining the amount of work completed is performed in dependence on a stage of the project, wherein determining the stage of the project is performed in dependence on a stage determination algorithm trained to recognise the stage of a project in dependence on the activity data from a plurality of the users.

24. The worksite evaluation method of claim 18, further comprising a step of determining an amount of work completed in dependence on the activity data of each of the users, and further comprising determining a degree of project completion in dependence on the amount of work completed.

25. The worksite evaluation method of claim 18, further comprising monitoring a user's exposure to a predetermined metric in dependence on the activity data, and
notifying the user when a threshold metric exposure amount has been exceeded.

26. The worksite evaluation method of claim 18, further comprising monitoring a user's exposure to a predetermined metric in dependence on the activity data, and notifying the user when a threshold metric exposure amount has been exceeded wherein the predetermined metric is hand and arm vibration.

27. The worksite evaluation method of claim 18, further comprising identifying users' slips and trips in dependence on the activity data, and generating a profile of risks in dependence the users' slips and trips.
